(19) United States
(12) Patent Application Publication
(10) Pub. No.: US 2014/0052614 A1
(43) Pub. Date: Feb. 20, 2014

(54) System and Method of Executing an Electronic Transaction Using an Embedded Trading Control

(71) Applicants: William S. Frischling, Great Falls, VA (US); Mark Eigenbauer, Dacula, GA (US); Jennifer L. Canty, Great Falls, VA (US); Erika Dickstein, Bethesda, MD (US)

(72) Inventors: William S. Frischling, Great Falls, VA (US); Mark Eigenbauer, Dacula, GA (US); Jennifer L. Canty, Great Falls, VA (US); Erika Dickstein, Bethesda, MD (US)

(21) Appl. No.: 13/873,053

(22) Filed: Apr. 29, 2013

Related U.S. Application Data
(63) Continuation of application No. 13/614,227, filed on Sep. 13, 2012, now abandoned.
Application No. 13/614,227 is a continuation of application No. 13/360,287, filed on Jan. 27, 2012, now abandoned.
Application No. 13/360,287 is a continuation of application No. 13/161,250, filed on Jun. 15, 2011, now abandoned.
Application No. 13/161,250 is a continuation of application No. 12/917,025, filed on Nov. 1, 2010, now abandoned.
Application No. 12/917,025 is a continuation of application No. 12/714,889, filed on Mar. 1, 2010, now abandoned.
(60) Provisional application No. 61/156,419, filed on Feb. 27, 2009.

(51) Int. Cl. G06Q 20/24

(52) U.S. Cl. CPC G06Q 20/24
USPC 705/39

(57) ABSTRACT

A user is enabled to access a first web page hosted on a first server. The first web page features an embedded trading control. The embedded trading control interfaces with an electronic catalog on a trade up server, enables the user to enter a description of a first item that the user intends to trade to a commercial intermediary in exchange for a credit applied to a user account for the user, and receives, from the electronic catalog on the trade up server, a proposal that includes trade in value for the first item. Using the embedded trading control, instructions from the user to trade in the first item are received so that a first item value in the user account is received. The user then may purchase a second item appearing in the second web page using the first item value in the user account.

### CROSS-REFERENCE TO RELATED APPLICATIONS

This application is a continuation of U.S. patent application Ser. No. 13/614,227, filed Sep. 13, 2012, which is a continuation of U.S. patent application Ser. No. 13/360,287, filed Jan. 27, 2012, which is a continuation of U.S. patent application Ser. No. 13/161,250, filed Jun. 15, 2011, which is a continuation of U.S. patent application Ser. No. 12/917,025, filed Nov. 1, 2010, now abandoned, which is a continuation of U.S. patent application Ser. No. 12/714,889, filed Mar. 1, 2010, now abandoned, which claims priority from U.S. Provisional Application No. 61/156,419, filed Feb. 27, 2009, and entitled, “AN EMBEDDED CONTROLLER FOR INLINE TRADING IN OF PRODUCTS.” The contents of the prior applications are incorporated herein in their entirety.

### TECHNICAL FIELD

This document relates to systems and methods to engage in electronic commerce.

### BACKGROUND

The growth of interactive digital networks has enabled users to engage in a variety of forms of electronic commerce. Using these interactive digital networks, a consumer may visit a web site to purchase a good or service. For example, a user may purchase a good using a credit card.

### SUMMARY

In one general sense, an electronic transaction is executed on a computer using a method. The method includes enabling a user to access a first web page hosted on a first server. The first web page features an embedded trading control that is structured and arranged to interface with an electronic catalog on a trade up server, enable the user to enter a description of a first item that the user intends to trade to a commercial intermediary in exchange for a credit applied to a user account for the user, receive, from the electronic catalog on the trade up server, a proposal that includes trade in value for the first item, enable the user to accept the proposal, and transfer the trade in value for the first item to the user account. Using the embedded trading control, instructions are received from the user to trade in the first item. Using the embedded trading control, a first item value in the user account is received. The user is enabled to access a second web page to purchase a second item appearing in the second web page using the first item value in the user account.

Implementations may include one or more of the following features. For example, enabling the user to access the first web page hosted on the first server may include enabling the user to interface with the embedded trading control without changing the portion of the first web page that is external to the embedded trading control. Enabling the user to interface with the electronic catalog on the trade up server may include enabling the user to interface with a single electronic catalog that is accessible through multiple merchant web sites. Enabling the user to interface with the single electronic catalog that is accessible through multiple merchant web sites may include enabling the user to interface with the embedded trading control on the first web site operated by a first merchant to trade in the first item, and enabling the user to interface with the embedded trading control on the second web site operated by a second merchant to purchase the item appearing in the second web page using the first item value for the first item as a credit.

The embedded trading control with a persistent presence may be maintained in a display as the user transitions from the first web page to the second web page. Maintaining the embedded trading control includes using the embedded trading control to load information about the user to the trade up server, loading the second web page, detecting an object in the second web page includes an association with the trade up server, using the object to load the embedded trading control with the information about the user from the trade up server, and enabling the user interface with the embedded trading controller for transactions within the second web page. The system also may display the embedded trading control on the second web page receive an instruction from the user to transition from the second web page to a third web page, determine that the third web page is not associated with the trade up server, and modify the embedded trading control so that the user perceives that the embedded trading control may not be used to purchase an item appearing in the third web page.

The system also may display the embedded trading control on the second web page, receive an instruction from the user to transition from the second web page to a third web page, determine that the third web page is not associated with the trade up server, and modify the embedded trading control so that the credit is applied to the user account in association with a transaction for the third web page without requiring the third web page to directly interface with the embedded trading control.

The system also may create a transaction shell for the user to receive the purchased item, create a confirmation interface into the transaction shell that indicates that the first item has been received, receive the indication that the first item has been received, and execute, based on receiving the indication, the transaction shell.

The system may delay the execution of the transaction shell until the indication has been received. The transaction shell may be executed without the credit for the first item value based on a determination that the first item has not been received. Receiving the first item value may include receiving points in an incentive program, receiving a check, receiving an electronic transfer of funds to the user account, receiving cash, or configuring a charitable donation using the benefits of trading in the first item.

Enabling the user to access the first web page and enabling the user to access a second web page may include enabling the user to access the first web page as a first portion of a display within a larger web page and enabling the user to access the second web page as a second portion of the display within the larger web page. Enabling the user to access the first web page and enabling the user to access a second web page may include branding the first web page and the second web page as vendor web pages and providing access to the trade up server while maintaining a branding of the first web page and the second web page as the vendor web pages.

Receiving instructions from the user to trade in the first item may include receiving a description of the item from a microcontroller embedded in the first item. Receiving instructions from the user to trade in the first item may include coupling the first item to an automated inventory reporting system, and receiving the description of the first item that the user intends to trade to the commercial intermediary from the automated inventory reporting system, routing the description of the first item from the automated inventory reporting system to the embedded trading control, and routing the description of the first item from the embedded trading control to the trade up server.

A mobile device may operate the embedded trading controller. The mobile device may electronically interrogate the first item to commence a trade in process. A mobile device may be used to operate the embedded trading controller, wherein the mobile device relies on a mobile device camera in order to ascertain the first item value.

The operations described above may be implemented on a computer system with a processor and stored as a computer program, so that the instructions may be executed on a processor.

The details of one or more implementations are set forth in the accompanying drawings and the description below. Other features will be apparent from the description and drawings, and from the claims.

### DESCRIPTION OF DRAWINGS

FIGS. 1-6 illustrate user interfaces that enable a user to engage in an electronic transaction using a trade up server.

FIG. 7 is a diagram of a communications system that enables a user to engage in an electronic transaction using a trade up server.

FIGS. 8-10 represent a flow chart of a process by which a user interfaces with a trade up server to engage in an electronic transaction.

### DETAILED DESCRIPTION

A vendor operates an electronic storefront that enables consumers and businesses to purchase goods and services. More precisely, the vendor may operate a web site with one or more commerce servers that enable the user to browse and purchase available inventory. Vendors may face a variety of challenges. For example, the rapid pace of technological progress may mean that a good sold today may rapidly become less desirable and valuable as additional products are released and revised in the future. As a result, some users desiring the latest products are caught in a never ending cycle of wanting to purchase constantly improving products. If a user is purchasing the constantly improving product, the user may be making less than desired utilization of previously-purchased products and/or not realizing the value for these products. Still, other users may be reluctant to engage in transactions over concerns that they will be unable to fully utilize previously-purchased products and/or not realize the value for these products. Still, tremendous value may exist for these previously-purchased products, particularly in markets where consumers do not require the latest products.

Thus, a vendor may offer a trade up server for use in electronic transactions. Generally, the trade up server is configured to interface with a vendor's electronic commerce server so that users may receive a credit for a good that they are trading in. The credit may be applied to reduce and/or defray the cost of a good that a user is purchasing from a vendor.

Specifically, electronic transactions may be executed by enabling a user to access a first web page hosted on a first server. The first web page may include a vendor web page (or a portion of a web page) on a vendor server. The first web page features an embedded trading control. The embedded trading control may include a toolbar application or an applet that assists the user with trading in products. The embedded trading control interfaces with an electronic catalog on a trade up server. The applet may include an HTML (“Hypertext Markup Language”) interface that enables the user to submit forms to the trade up server. The submitted form then may be compared with an electronic catalog so that the trade up server can precisely identify the value of the item being considered for a trade in by looking up detailed information in a database. The embedded trading control also enables the user to enter a description of a first item that the user intends to trade to a commercial intermediary in exchange for a credit applied to a user account for the user. For example, the user may interact with a series of dropdown menus in order to identify a specific make and serial number. As a result of receiving a specific identification of the serial number, a proposal that includes trade in value for the first item is received from the electronic catalog on the trade up server.

The embedding trading control enables the user to accept the proposal. Enabling the user to accept the proposal may include displaying an “accept” button that executes the transaction. The embedded trading control also enables the user to receive the trade in value for the first item and then transfers the trade in value to the user account.

With the embedded trading control so configured, instructions from the user to trade in the first item are received using the embedded trading control and a first item value is received in the user account. For example, the user enters a make and model of a back up hard drive in a toolbar-based embedded trading control and receives a credit for the back up hard drive in the user account. The user is then enabled to access a second web page. The second web page may include a different portion of the same web page that features the first web page. The user is enabled to purchase a second item appearing in the second web page using the first item value in the user account. The user thus may purchase a new back up hard drive using the credit from the first hard drive.

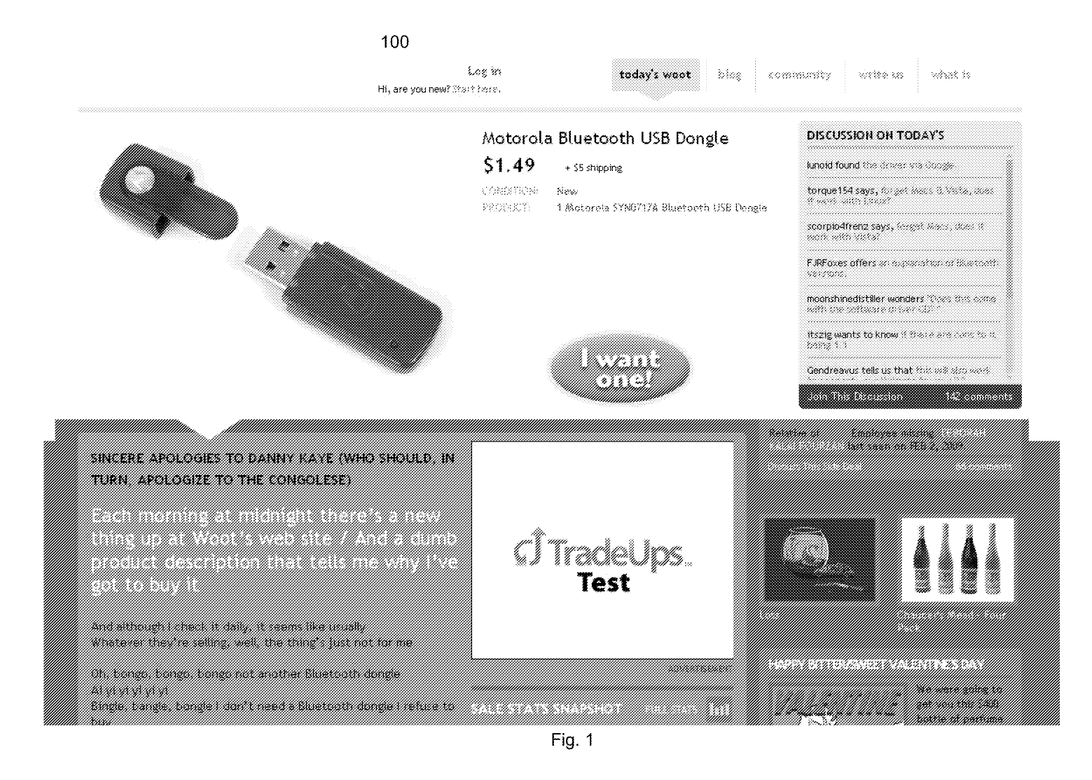

FIGS. 1-6 illustrate user interfaces that enable a user to engage in an electronic transaction using a trade up server. Generally, FIGS. 1-6 illustrate the user interface that enables a user to launch an embedded trading control, interact with the embedded trading control in order to trade in an item, and receive a credit for trading the item in. In FIG. 1, user interface 100 illustrates a web page on a first web site. The web page includes a description of an item being offered for sale. In one portion of the web page, the user may select “I want one!” in order to purchase the USB (“Universal Serial Bus”) Bluetooth interface that is shown. In a second portion of the web page, a link is shown that launches a test to determine whether the user is able to launch the embedded trading control. Specifically, the user may select, “TradeUps Test” in order to launch a test to determine whether the embedded trading control can be launched.

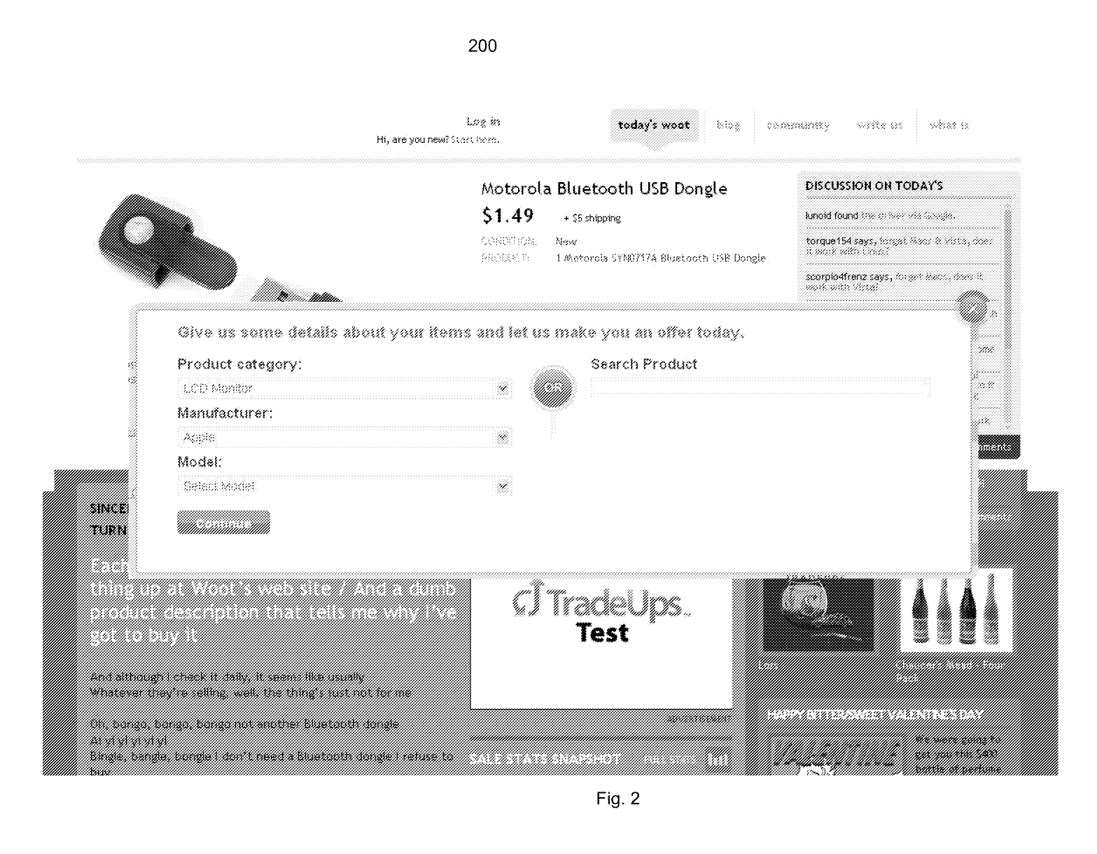

FIG. 2 features a user interface 200 that displays the embedded trading control as part of the same inline experience. User interface 200 provides an inline experience because the user is permitted to interact with the embedded trading control without requiring the user to change the underlying web page that the user was viewing. As shown, user interface 200 enables the user to both specify a configuration for a LCD monitor that the user is trading in, and also perceive the USB Bluetooth interface that the user was browsing. Note that the embedded trading control features both a search interface to identify the item being traded in as well as a series of dropdown menus that enable the user to identify the item with particularity.

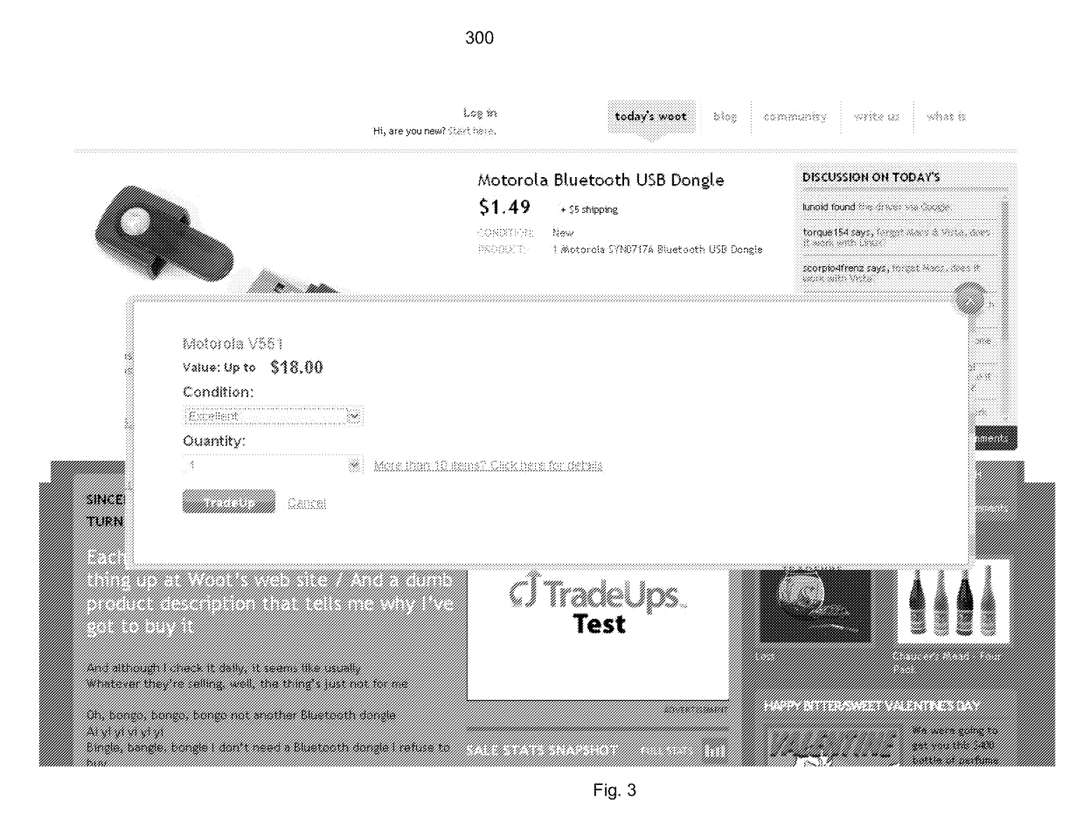

FIG. 3 illustrates a user interface 300 in an embedded trading control that enables the user to perceive the value for a prospective trade in item. User interface enables the user to specify the quantity and the condition of the item being traded in. The user may select the offer for the item by selecting the “trade up” button.

The value for an item being traded often depends on the condition for the item. In one implementation, the user is required to send a photograph of the item in order to verify the condition of the item. For example, the embedded trading controller may be configured to interface with a camera on a wireless phone. In another implementation, the item being traded in includes a microcontroller that identifies the make, model, and condition of the item. For instance, a user may wish to trade in a wireless phone. The embedded trading control may interface with a microcontroller on the wireless phone using, for example, a Bluetooth interface or USB synchronization cable. The microcontroller may report make and model information. The microcontroller also may report recent performance information such as the percentage of dropped calls, a hardware diagnostics report, and the estimated condition of the batteries. This information may be used to verify and/or revise the value for the item being traded in.

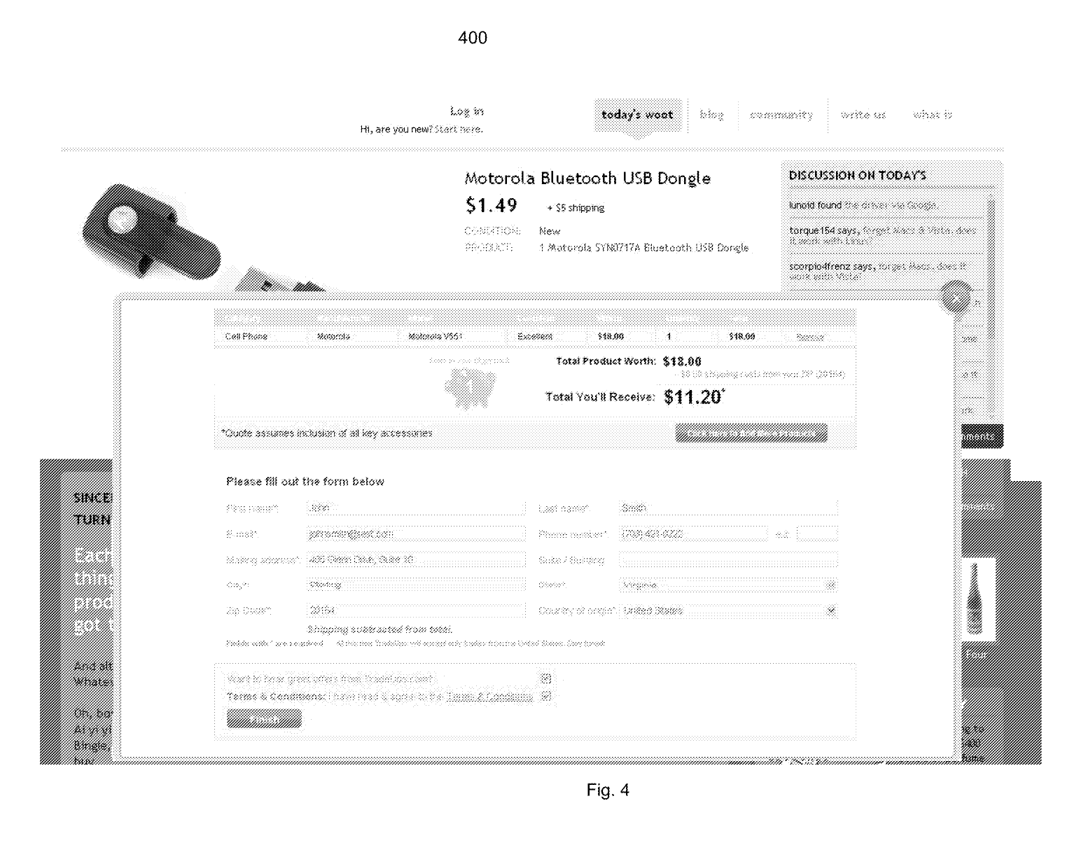

FIG. 4 illustrates a user interface 400 that identifies the value of the item and the net impact of the proposed trade in on a credit for a user account. As shown, the value of the item is offset by the cost of shipping. Also note that the user is specifically identified with a user account. In one configuration, the user account is associated with a particular vendor. Thus, each particular embedded trading control may be precluded from use on other vendor web sites. In another configuration, the embedded trading control is operable across multiple vendor web sites. For example, the operator of the trade up server may operate the trade in service as a value added service. One or more vendors may sign up to interface with the trade in value added service in order to better distinguish themselves from vendors that do not offer the trade in service.

The embedded trading control may be modified to reflect the relationship with the underlying vendor. In a first configuration where the embedded trading control is tied to a particular vendor, the embedded trading control may be configured to save its state (e.g., credit in the user account) and terminate upon determining that the user has switched to a web site operated by a different vendor. Alternatively, the embedded trading control may persist but indicate that the embedded trading control is now disabled on the new web site. In a second configuration where the embedded trading control is portable across some, but not all other vendor web sites, the embedded trading control may be selectively grayed out as the navigates to web sites that do not support the embedded trading control and activated upon returning to a web site that supports the embedded trading control. In yet another configuration, the embedded trading control displays different values for different products with different vendors. Thus, a first product may merit a first value with a first vendor and a second value with a second vendor.

As the user transitions between different web pages and different vendors, the web page may be configured to maintain the embedded trading control by updating user account information on the trade up server. For example, a first web page may feature a javascript control configured to automatically update the account information upon detecting a user exit from the first web page (e.g., by terminating the viewing window and/or selecting a new link). A second web page (e.g., the linked to page) may include another javascript control that automatically references the user account on the trade up server. The second web page then may automatically launch the embedded trading control so that the user has access to the same information in the second web page that the user perceived in the first web page.

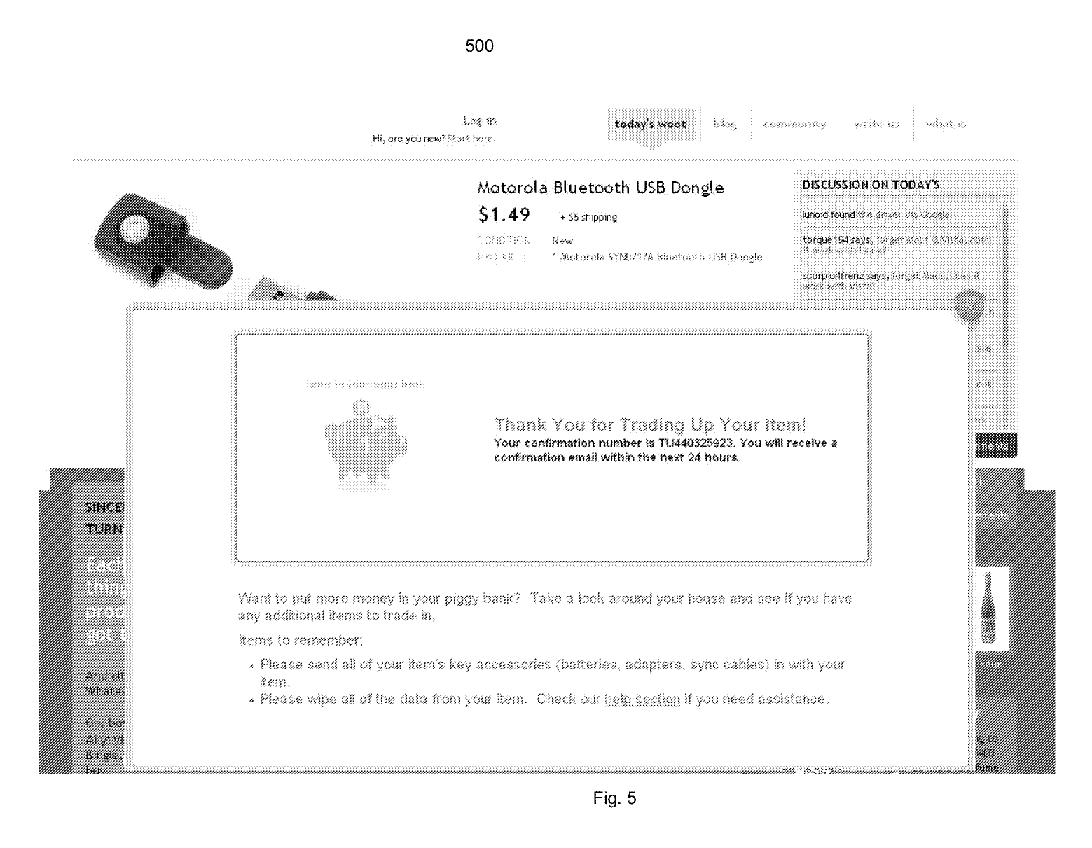

FIG. 5 includes a user interface 500 that illustrates that the proposed trade in transaction has been confirmed. The trade up server may apply the credit in a variety of manners. In a first configuration, a transaction shell is created that suspends a transaction until receipt of the trade in item receipt. When the receivables department determines that the item has been received and that the item satisfies the proposed transaction, a logistics server may transmit a message to a transaction server within the first web site. The message then may be routed to the transaction shell, which in turn performs the transaction and ships the purchased good. In another configuration, the transaction shell gives the user a window of time to ship the item in order to receive the credit. After the window of time has elapsed, the transaction may be executed without crediting the user account. In yet another example, the transaction may be automatically executed if the item has not been received. The credit may be stored for application in a future transaction if it is later received.

In yet another configuration, the trade up server is configured to support the transaction without establishing a relationship with the vendor. For instance, the user may trade in items and establish a credit in an account with the trade up server. The trade up server then may route that credit through a user account and/or use the trade up server account to purchase desired items from a vendor. Thus, the trade up server may debit additional resources directly from the user and combine the debited resources with the previously established credit in order to provide the necessary funds.

The trade up server may be configured to pass data back to the web site server using an API (“Application Programming Interface”) call that indicates which items have been purchased. The vendor operating the web site server may appreciate this market intelligence and use this information to revise vendor prices, advertising, and inventory. For example, determining that a number of users are trading in external hard drives may be identified as indicia of an increased demand for replacement external hard drives. Thus, the vendor may automatically increase inventory, adjust prices, and/or revise the advertising campaign to showcase external hard drives.

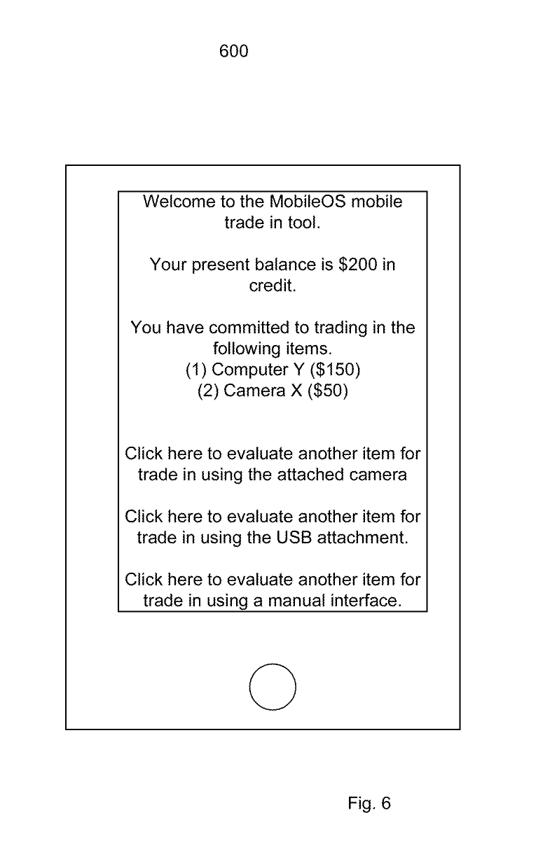

FIG. 6 is a user interface 600 of an embedded trading control that enables a user to interface with a mobile device to enter items to trade in. As shown, user interface 600 indicates that the user has a credit of $200, which is based upon receiving $150 for a computer and $50 for a camera. The user is then presented with three options for entering an item. First, the user is permitted to evaluate another item by taking a picture of the item. Taking a picture of an item may launch a process that enables the item to be evaluated for inclusion in a trade up process. In one configuration, the item is analyzed in an automated manner, for example, by inspecting for defects in an exterior surface. In another configuration, the item is evaluated by a remote human operator. The user also may connect the mobile device to a USB (“Universal Serial Bus”) interface that enables the mobile device to automatically scan the item being evaluated. Attaching the USB interface may install a microcontroller than reports back to the mobile device and/or the trade up server. Finally, the user may manually create an entry to evaluate another device.

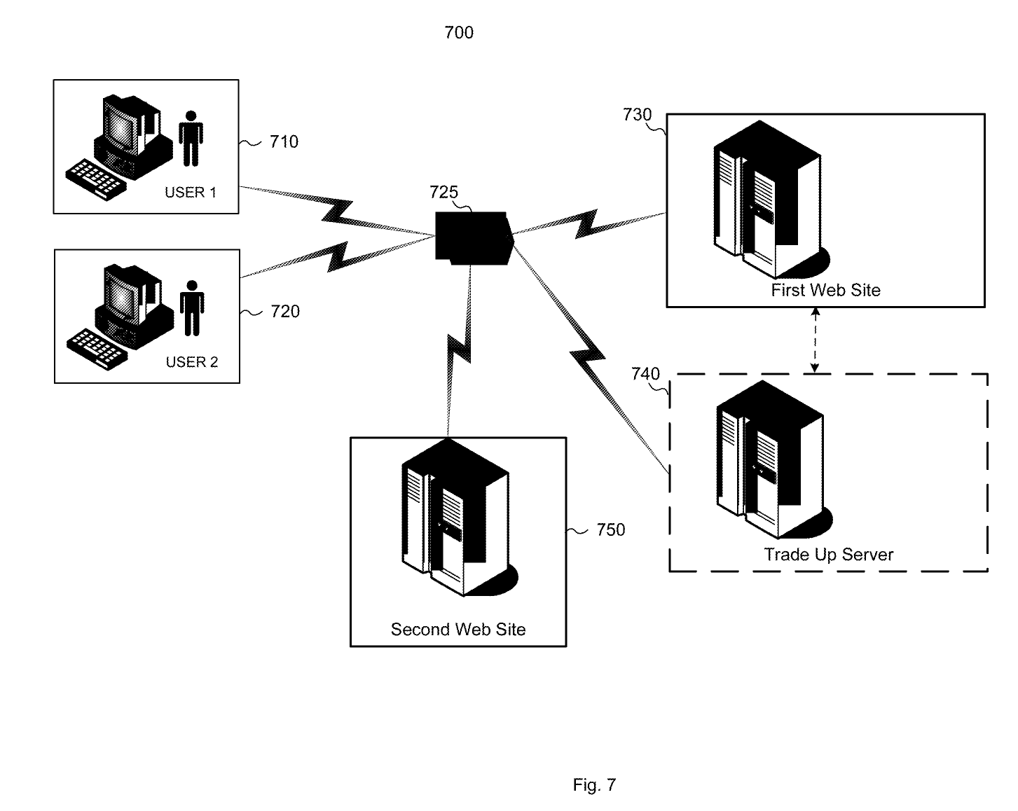

FIG. 7 is a diagram of a communications system that enables a user to engage in an electronic transaction using a trade up server. Specifically, FIG. 7 is a block diagram of an exemplary communications system 700 configured to enable a client 710 to use a network 725 to interface with a first web site 730 and a trade up server 740. Generally, the client 710 is configured to interface with a variety of vendors operating web sites (e.g., first web site 730 and second web site 750). Specifically, the client 710 enables a user to access a first web page hosted on a first web site 730. The client 710 is configured to load a first web page featuring an embedded trading control. The embedded trading control on the client 710 is configured to interface with an electronic catalog on a trade up server, enable the user to enter a description of a first item that the user intends to trade to a commercial intermediary in exchange for a credit applied to a user account for the user, receive, from the electronic catalog on the trade up server, a proposal that includes trade in value for the first item, enable the user to accept the proposal, and transfer the trade in value for the first item to the user account.

The client 710 typically includes a computing device enabling a user to exchange information over a communications network. The client 710 may include one or more devices capable of accessing content residing on first and second web sites 730 and 750 and on the trade up server 740. The client 710 may include a controller (not shown) that processes instructions received from or generated by a software application, a program, a piece of code, a device, a computer, a computer system, or a combination thereof, which independently or collectively direct operations of the client 710. The instructions may be embodied permanently or temporarily in any type of machine, component, equipment, storage medium, or propagated signal that is capable of being delivered to the client 710 or that may reside with the controller at client 710. Client 710 may include a general-purpose computer (e.g., a personal computer (PC)) capable of responding to and executing instructions in a defined manner, a workstation, a notebook computer, a PDA (“Personal Digital Assistant”), a wireless phone, a component, other equipment, or some combination of these items that is capable of responding to and executing instructions.

In one implementation, the client 710 includes one or more information retrieval software applications (e.g., a browser, a mail application, an instant messaging client, an Internet service provider client, or an interactive television or other integrated client) capable of receiving one or more data units. The information retrieval applications may run on a general-purpose operating system and a hardware platform that includes a general-purpose processor and specialized hardware for graphics, communications and/or other capabilities.

In another implementation, client 710 may include a wireless telephone running a micro-browser application on a reduced operating system with general purpose and specialized hardware capable of operating in mobile environments.

The embedded trading control may be implemented in HTML 5 as a persistent application, a Java application, a javascript controller, an application in the iPhoneOS or Android operating systems and/or as a toolbar program.

The client 710 may include one or more media applications. For example, the client 710 may include a software application that enables the client 710 to capture, receive and display an audio or video data stream. The media applications may include controls that enable a user to configure the user's media environment. For example, if the media application is receiving an Internet radio station, the media application may include controls that enable the user to select an Internet radio station, for example, through the use of “preset” icons indicating the station genre (e.g., country) or a favorite.

The network 725 typically includes hardware and/or software capable of enabling direct or indirect communications between the client 710 and first and second web sites 730 and 750 and the trade up server 740. As such, the network 725 may include a direct link between the client 710 and first and second web sites 730 and 750 and the trade up server 740, or it may include one or more networks or subnetworks between them (not shown). Each network or subnetwork may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

First and second web sites 730 and 750 generally include one or more devices configured to facilitate electronic commerce and execute electronic transactions. Typically, a first web site 730 includes a collection or library of products for purchase. Alternatively, or in addition, the first web site 730 may convert a supplier inventory from a supplier source (e.g., a manufacturer) into an electronic catalog for access across the network 725. The first web site may include a general-purpose computer having a central processor unit (CPU), and memory/storage devices that store data and various programs such as an operating system and one or more application programs. Other examples of the first web site 730 includes a workstation, a server, a special purpose device or component, a broadcast system, other equipment, or some combination thereof capable of responding to and executing instructions in a defined manner. The first web site 730 also may include an input/output (I/O) device (e.g., video and audio input and conversion capability), and peripheral equipment such as a communications card or device (e.g., a modem or a network adapter) for exchanging data with the network 725.

First and second web sites 730 and 750 and the trade up server 740 are generally capable of executing instructions under the command of a controller. The first and second web sites typically are similar in that each of the web sites in the group that includes a catalog that may be accessed by the client 710. For illustrative purposes, the operation of first and second web sites 730 and 750 and the trade up server 740 will be described with respect to first web site 730. Thus, aspects of the description of first web site 730 may be applicable to description of the second web site 750 and the trade up server 740. The two web sites are shown to illustrate that the client 710 may interface with two or more web sites operated by two or more vendors with support from the trade up server 740 for transactions with both web sites. While the web sites may include similar or even identical components, applications, data, and configuration information, first and second web sites 730 and 750 and the trade up server 740 need not be identical.

The controller on a web site may be implemented by a software application loaded on the first web site 730 for commanding and directing communications exchanged with the client 710. Other examples of the controller include a program, a piece of code, an instruction, a device, a computer, a computer system, or a combination thereof, for independently or collectively instructing the client 710 or the first web site to interact and operate as described. The first web site may be embodied permanently or temporarily in any type of machine, component, physical or virtual equipment, storage medium, or propagated signal capable of providing instructions to the client 710 or the first web site 730.

The trade up server 740 may be configured to host an API and interface so that the user on the client 710 only perceives that they are interacting with the first web site 710. That is, because the embedded trading control is presented as part of an inline experience, the user may not perceive that they are interacting with the trade up server 740, which is logically positioned in the back office of vendor operations for the vendor operating the first web site server. For example, irrespective of whether the user engages in the transaction proposed by the embedded trading control, the user may be returned and/or continuously perceive the first web page that was used to launch the embedded trading control.

The second client 720 may be similar to the first client 710. In one configuration, the stimuli and input received by the second client 720 are used to modify the interface to the first client by the trade up server 740. For example, if the second client is creating a demand for a certain class of products, the trade up server 740 may be configured to increase the value of the items offered to the first client 710 in order to inspire a trade in of the goods by the first client 710. Likewise, if the second client 720 is interested in trading in similar goods, the trade up server 740 may be configured to revise the price accordingly.

In one configuration, the trade up server 730 is configured to receive stimuli from suppliers. For example, if a supplier determines that a certain product is tarnishing the suppliers brand name due to poor performance, the trade up server may be configured to participate in a broader recall campaign in order to inspire consumers to trade the particular item.

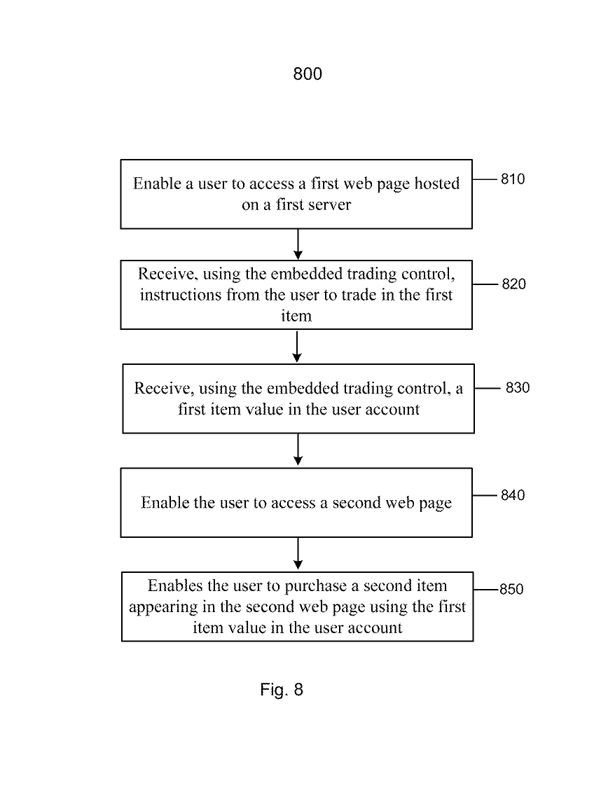

FIGS. 8-10 represent flow charts of processes by which a user interfaces with a trade up server to engage in an electronic transaction. Generally, the operations described in FIG. 8-10 are performed to create the user interface shown in FIGS. 1-6 using the systems described in FIG. 7. FIG. 8 illustrates a flow chart of a process 800 by which an electronic transaction is executed on a computer. The client enables a user to access a first web page hosted on a first server (810). The first web page features an embedded trading control that is structured and arranged to interface with an electronic catalog on a trade up server. The embedded trading control also enables the user to enter a description of a first item that the user intends to trade to a commercial intermediary in exchange for a credit applied to a user account for the user and receive, from the electronic catalog on the trade up server, a proposal that includes trade in value for the first item. The embedded trading control also enables the user to accept the proposal, and transfer the trade in value for the first item to the user account.

The client then receives, using the embedded trading control, instructions from the user to trade in the first item (820). For example, the user may have completed the forms shown in FIGS. 1-6 in order to identify an item that will be traded in. The user then receives, using the embedded trading control, a first item value in the user account (830). The user may have traded in an older computer in order to purchase a new computer and wish to apply a credit for the old computer to the new computer. The client then enables the user to access a second web page (840). In one configuration, the first web page and the second web page are the same. For example, the first web page may include the portion of the web page that is used to launch the embedded trading control and the second web page may include the portion of the web page that is used to present an item for purchase.

In one configuration the first web page is hosted by a first organization (e.g., a first vendor or a trade up service provider) and the second web page is hosted by a second organization (e.g., a second vendor).

The client then enables the user to purchase a second item appearing in the second web page using the first item value in the user account (850). For example, the client may elect to purchase a portable media device.

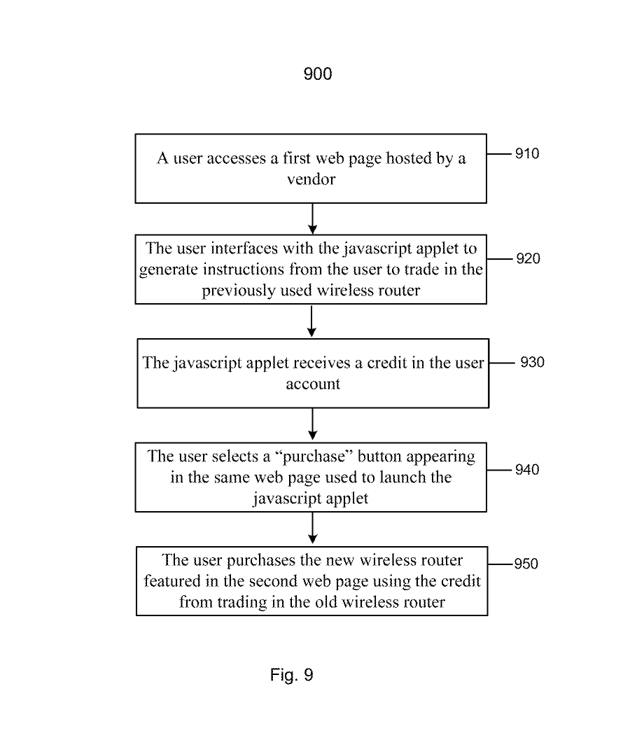

FIG. 9 illustrates a flow chart of a process 900 by which an electronic transaction is executed on a computer. Generally, the operations shown in process 900 relate to the operations described previously in process 800. However, the operations shown in process 900 are directed to a particular implementation.

First, a user accesses a first web page hosted by a vendor (910). The first web page includes a listing from an electronic catalog that enables the user to purchase a wireless router. The first web page features a javascript applet acting as an embedded trading control. The javascript applet is configured to present a vendor-branded HTML interface to the trade up server. The javascript applet interfaces with an electronic catalog on a trade up server so that the user can identify a wireless router being traded in with particularity.

The user then interfaces with the javascript applet to generate instructions from the user to trade in the previously used wireless router (920). The javascript applet then receives a credit in the user account (930). In one configuration, the credit includes a donation to a charitable organization on the user's behalf. In another configuration, the credit includes cash, a check, and/or points in an incentive program that are transferred to the user. In yet another configuration, the credit includes a positive balance that is transferred to an electronic ledger. The user then accesses a portion of the web page to purchase the new wireless router. The user selects a “purchase” button appearing in the same web page used to launch the javascript applet (940). The user then purchases the new wireless router featured in the second web page using the credit from trading in the old wireless router (950).

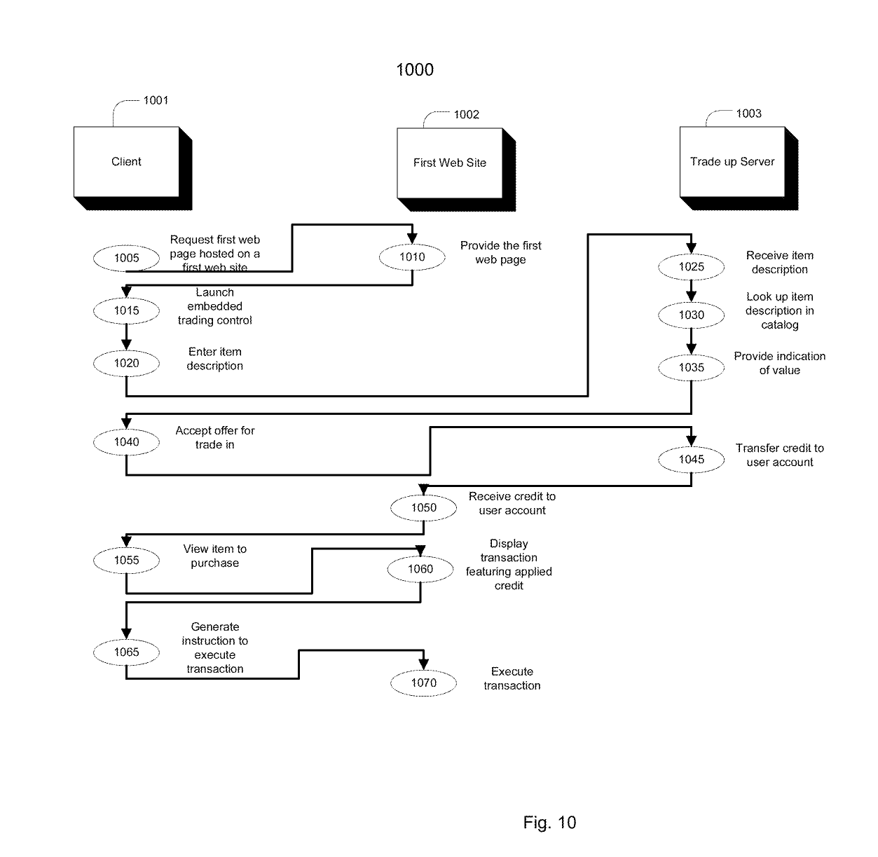

FIG. 10 is a flow chart of a process 1000 by which a client 1001 interfaces with a first web site 1002 and a trade up server 1003 to execute a transaction. Generally, the operations shown in process 1000 relate to the operations described previously in process 800 and 900. However, the operations shown in process 1000 are directed to a particular implementation whereby the client 1001, the first web site 1002, and a trade up server 1003 each perform certain operations. Other implementations may feature different systems performing different operations.

Initially, the client 1001 requests a first web page hosted on the first web site 1002 (1005). The first web site 1002 provides the first web page (1010). The client 1001 launches the embedded trading control (1015). For example, the first web page may include javascript and HTML code that launches the applications shown in FIGS. 1-6. The client 1001 then enters an item description (1020).

The trade up server 1003 then receives the item description (1025), looks up the item description in a catalog (1030), and provides an indication of value (1035). The client 1001 accepts the trade in offer (1040), which causes the trade up server 1003 to transfer credit to the user account (1045).

The first web site 1050 then receives the credit to the user account (1050). The client 1001 then views an item to purchase (1055), and displays the transaction featuring the applied credit (1060). The client 1001 then generates an instruction to execute the transaction (1065) and executes the transaction (1070).

Although process 1000 illustrated the client 1001 interfacing directly with the trade up server 1003, in another configuration, the client 1001 also may interface with the trade up server through the first web site 1002. That is, the first web site 1002 may be configured to exchanging information between the client 1001 and the trade up server 1003 using an API.

Other implementations are within the scope of the claims. For example, many of the operations were described in the context of a client and/or user performing an operation. Typically, these operations involve a user interacting with the client to effectuate an exchange of information with the web site server and/or with the trade up server.

In another example, although some of the examples described trading in actual goods, the operations also may be used to engage in transactions for virtual goods, software, and services. Where permitted by end user license agreements (EULA), the user may load a piece of software being traded in to a virtual server. Receipt of the software on the virtual machine then may trigger execution of the transaction shell. The loaded piece of software then may be resold as permitted by the EULA.

What is claimed is:

1. A method of executing an electronic transaction on a computer, the method comprising:
enabling a user to access a first web page hosted on a first server, the first web page featuring an embedded trading control that is structured and arranged to:
interface with an electronic catalog on a trade up server,
enable the user to enter a description of a first item that the user intends to trade to a commercial intermediary in exchange for a credit applied to a user account for the user,
receive, from the electronic catalog on the trade up server, a proposal that includes trade in value for the first item,
enable the user to accept the proposal,
transfer the trade in value for the first item to the user account,
receiving, using the embedded trading control, instructions from the user to trade in the first item;
receiving, using the embedded trading control, a first item value in the user account;
enabling the user to access a second web page; and
enabling the user to purchase a second item appearing in the second web page using the first item value in the user account.

2. The method of claim 1 wherein enabling the user to access the first web page hosted on the first server includes enabling the user to interface with the embedded trading control without changing the portion of the first web page that is external to the embedded trading control.

3. The method of claim 1 wherein enabling the user to interface with the electronic catalog on the trade up server includes enabling the user to interface with a single electronic catalog that is accessible through multiple merchant web sites.

4. The method of claim 3 wherein enabling the user to interface with the single electronic catalog that is accessible through multiple merchant web sites includes:
enabling the user to interface with the embedded trading control on the first web site operated by a first merchant to trade in the first item, and
enabling the user to interface with the embedded trading control on the second web site operated by a second merchant to purchase the item appearing in the second web page using the first item value for the first item as a credit.

5. The method of claim 1 further comprising maintaining the embedded trading control with a persistent presence in a display as the user transitions from the first web page to the second web page.

6. The method of claim 5 wherein maintaining the embedded trading control includes using the embedded trading control to load information about the user to the trade up server, loading the second web page, detecting an object in the second web page includes an association with the trade up server, using the object to load the embedded trading control with the information about the user from the trade up server, and enabling the user interface with the embedded trading controller for transactions within the second web page.

7. The method of claim 5 further comprising:
displaying the embedded trading control on the second web page;
receiving an instruction from the user to transition from the second web page to a third web page;
determining that the third web page is not associated with the trade up server; and
modifying the embedded trading control so that the user perceives that the embedded trading control may not be used to purchase an item appearing in the third web page.

8. The method of claim 5 further comprising:
displaying the embedded trading control on the second web page;
receiving an instruction from the user to transition from the second web page to a third web page;
determining that the third web page is not associated with the trade up server; and
modifying the embedded trading control so that the credit is applied to the user account in association with a transaction for the third web page without requiring the third web page to directly interface with the embedded trading control.

9. The method of claim 1 further comprising:
creating a transaction shell for the user to receive the purchased item;
creating a confirmation interface into the transaction shell that indicates that the first item has been received;
receiving the indication that the first item has been received;
executing, based on receiving the indication, the transaction shell.

10. The method of claim 9 further comprising delaying the execution of the transaction shell until the indication has been received.

11. The method of claim 9 further comprising executing the transaction shell without the credit for the first item value based on a determination that the first item has not been received.

12. The method of claim 1 wherein the receiving the first item value includes receiving points in an incentive program, receiving a check, receiving an electronic transfer of funds to the user account, receiving cash, or configuring a charitable donation using the benefits of trading in the first item.

13. The method of claim 1 wherein enabling the user to access the first web page and enabling the user to access a second web page includes enabling the user to access the first web page as a first portion of a display within a larger web page and enabling the user to access the second web page as a second portion of the display within the larger web page.

14. The method of claim 1 wherein enabling the user to access the first web page and enabling the user to access a second web page includes branding the first web page and the second web page as vendor web pages and providing access to the trade up server while maintaining a branding of the first web page and the second web page as the vendor web pages.

15. The method of claim 1 wherein receiving instructions from the user to trade in the first item includes receiving a description of the item from a microcontroller embedded in the first item.

16. The method of claim 1 wherein receiving instructions from the user to trade in the first item includes:
coupling the first item to an automated inventory reporting system;
receiving the description of the first item that the user intends to trade to the commercial intermediary from the automated inventory reporting system;
routing the description of the first item from the automated inventory reporting system to the embedded trading control; and
routing the description of the first item from the embedded trading control to the trade up server.

17. The method of claim 1 further comprising using a mobile device to operate the embedded trading controller, wherein the mobile device electronically interrogates the first item to commence a trade in process.

18. The method of claim 1 further comprising using a mobile device to operate the embedded trading controller, wherein the mobile device relies on a mobile device camera in order to ascertain the first item value.

19. A computer system structured and arranged to execute an electronic transaction on a computer, the system comprising:
a processor:
instructions stored on a computer readable medium that when executed on the processor cause the processor to:
enable a user to access a first web page hosted on a first server, the first web page featuring an embedded trading control that is structured and arranged to:
interface with an electronic catalog on a trade up server,
enable the user to enter a description of a first item that the user intends to trade to a commercial intermediary in exchange for a credit applied to a user account for the user,
receive, from the electronic catalog on the trade up server, a proposal that includes trade in value for the first item,
enable the user to accept the proposal,
transfer the trade in value for the first item to the user account,
receive, using the embedded trading control, instructions from the user to trade in the first item;
receive, using the embedded trading control, a first item value in the user account;
enable the user to access a second web page; and
enable the user to purchase a second item appearing in the second web page using the first item value in the user account.

20. A computer program stored on a computer readable medium, the computer program comprising instructions that when executed on a processor cause the processor to:
enable a user to access a first web page hosted on a first server, the first web page featuring an embedded trading control that is structured and arranged to:
interface with an electronic catalog on a trade up server,
enable the user to enter a description of a first item that the user intends to trade to a commercial intermediary in exchange for a credit applied to a user account for the user,
receive, from the electronic catalog on the trade up server, a proposal that includes trade in value for the first item,
enable the user to accept the proposal,
transfer the trade in value for the first item to the user account,
receive, using the embedded trading control, instructions from the user to trade in the first item;
receive, using the embedded trading control, a first item value in the user account;
enable the user to access a second web page; and
enable the user to purchase a second item appearing in the second web page using the first item value in the user account.
